(19) United States
(12) Patent Application Publication
(10) Pub. No.: US 2009/0272499 A1
(43) Pub. Date: Nov. 5, 2009

(54) Stripping device for a press

(76) Inventor: Paolo Quercia, Pierrefonds (CA)

Correspondence Address: Franz BONSANG;c/o EQUINOX PROTECTION, 410 - 1500, Du College, St-Laurent, QC, H4L 5G6, CA

(21) Appl. No.: 12/149,615

(22) Filed: May 5, 2008

(51) Int. Cl. B32B 38/10

(52) U.S. Cl. 156/584

(57) ABSTRACT

A stripping device for stripping a waste piece from a sheet in a press has a resilient connecting portion connecting supporting finger connected to a frame of the press and a cogwheel disposed proximal an aperture of the frame. The cogwheel is aligned in register with a die in a first configuration of the device and slides along the cogwheel in contact with the waste piece to deflect, and thereby strip, the waste piece. The die also biases the cogwheel towards the finger as it is rotated until the device is in a second configuration in which the cogwheel is aligned for biasing back into the first configuration when the die is removed from contact with the cogwheel.

### FIELD OF THE INVENTION

The present invention concerns mechanical devices, more particularly to mechanical devices for stripping waste from a pre-cut sheet of material.

### BACKGROUND OF THE INVENTION

Presses for cutting sheet material such as paper, paperboard, cardboard and the like, are well known. When the sheet material is pre-cut and includes pre-cut portions, which need to be stripped out as waste pieces, the presses include stripping devices or stations. One such stripping station is disclosed in U.S. Pat. No. 3,786,731, issued to Bobst et al. on Jan. 22, 1974 for “Press for Cutting Sheet Material”. Bobst discloses stripping stations, which include a pair of frames and a board, which has a series of pre-cut die openings, which are shaped to the desired design. Stripping tools are mounted to the frames and sandwich the waste material therebetween once the sheet material is moved horizontally between the two frames. The stripping tools work together to remove the waste material. One problem, however, the stripping stations may operate too slowly for use with a high throughput stripping. U.S. Pat. No. 5,181,640, issued to Vossen et al. on Jan. 26, 1993 teaches a stripping station or device that works on similar principles, with a die punching the waste piece from the pre-cut material and passing through rollers which assist in rolling the waste piece away from the sheet.

Unfortunately, for the devices taught by both Bobst et al. and Vossen et al., paper jams may occur frequently once the waste piece has been removed or while the waste piece is being removed. For example, for the device shown by Vossen et al., the waste piece may become stuck between the rollers. When a paper jam occurs, the press and stripping device must be shut down, often for a significant amount of time, while the jam is removed. Such shutdowns are frustrating for users and manufacturers and cause loss of both time and money while the paper jam is removed.

Accordingly, there is a need for an improved stripping device.

### SUMMARY OF THE INVENTION

It is therefore a general object of the present invention to provide an improved stripping device.

An advantage of the present invention is that the stripping device can be easily retrofitted into an existing pressing machine to strip waste portions from a pre-cut sheet, without the need for complex machinery.

A further advantage of the present invention is the stripping device is constructed from inexpensive materials.

Yet another advantage of the present invention is that, for the stripping device provided thereby, the occurrence of paper jams is significantly reduced or eliminated.

Still another advantage of the present invention is that the stripping device enables significantly increased stripping speeds and, therefore, more rapid pressing of the sheets.

In accordance with an embodiment of the present invention, there is provided a stripping device for stripping a waste piece from a sheet of material by a die of a press when the press is extended in a first direction through an aperture of a frame of the press with which the waste piece is aligned, a first die end of the die tearing the waste piece from the sheet as the die extends through the sheet in the first direction, the device comprising:
a resilient connecting portion having generally opposite first and second connecting sides;
a supporting finger extending from the first connecting side and having a connecting end connectable to the frame; and
a cogwheel rotatably mounted on an extending end of at least one arm extending from the second connecting side and including at least three adjoined peripheral faces connected to one another at corresponding edges, the cogwheel being aligned, in a first configuration for the device, with one face of the peripheral faces facing the waste piece and the die and being in register with the die and for rotating of the cogwheel by sliding of the die along a portion of the one face with the waste piece disposed therebetween as the die is extended in the first direction, thereby deflecting the waste piece away from the sheet, and biasing the cogwheel inwardly towards the supporting finger until the one face, in a second configuration for the device, extends substantially alongside the die in an orientation generally parallel to the first direction and in at least partial side contact therewith and a next adjacent face of the peripheral faces is positioned for subsequent sliding of the die therealong with the cogwheel being resiliently biased away from the supporting finger when the die is removed from side contact therewith, the device being returned thereby to the first configuration.

### BRIEF DESCRIPTION OF THE DRAWINGS

Further aspects and advantages of the present invention will become better understood with reference to the description in association with the following Figures, in which:

FIG. 1 is a simplified perspective view of a die cutting press with a pair of stripping frames showing an embodiment of a stripping device in accordance with the present invention;

FIG. 2 is a simplified exploded view of the stripping device shown in FIG. 1;

FIG. 3 is a simplified side view of the stripping device in a first, default configuration;

FIG. 4 is a simplified side view of the stripping device being initially engaged by a die of the press and having a cogwheel thereof rotated thereby out of the first configuration while contacting a waste piece from a sheet of material;

FIG. 5 is a simplified side view of the stripping device as the die continues to rotate the cogwheel and biases the cogwheel towards a supporting finger of the device, the die moving the device towards a second configuration as the waste piece is removed from the sheet;

FIG. 6 is a simplified side view of the stripping device in a second configuration with the waste piece removed from the sheet and moving away therefrom;

FIG. 7 is a perspective view of a stripping device in accordance with an alternative embodiment of the present invention; and

FIG. 8 is a sectional view of the stripping device shown in FIG. 7.

### DETAILED DESCRIPTION OF THE PREFERRED EMBODIMENTS

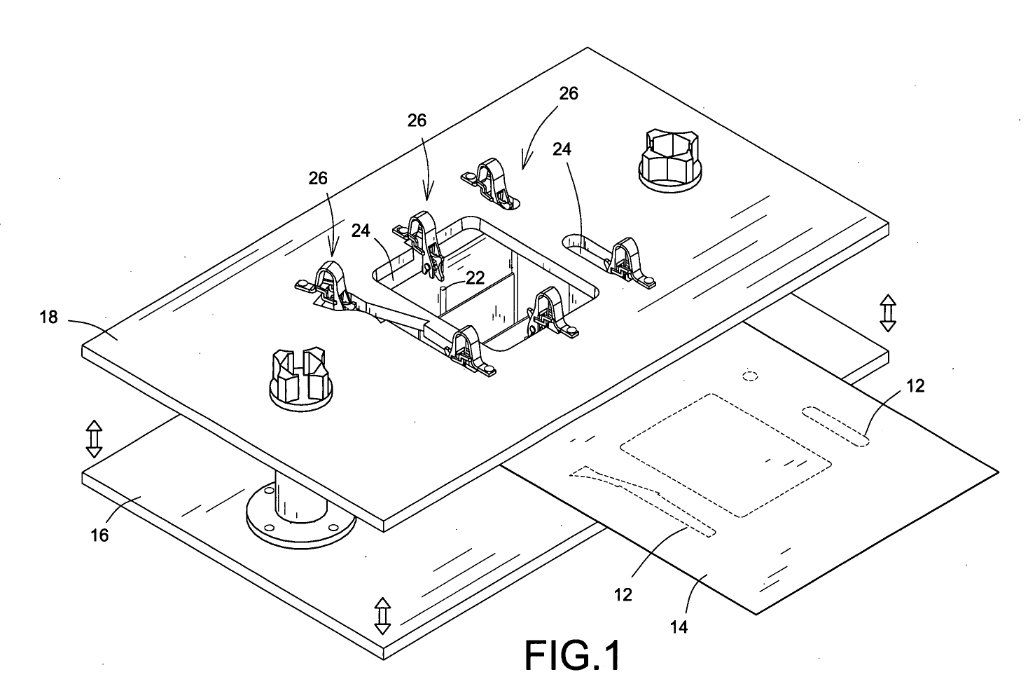

Referring now to FIG. 1, a press for pressing sheets of material, such as paper, is shown generally as 10. The press 10 is used to remove waste pieces of material 12 from pre-cut sheets of material 14, which is typically paper, paperboard, cardboard and the like. The pre-cut sheet of material 14 is typically a template for many applications. Examples include, but are not limited to, backing sheets for a blister package, blanks for constructing paperboard cartons and the like. The press 10 is a die-cutting press of a conventional design known to those skilled in the art and includes a pair of connected planar body press frames 16, 18, which may be mounted within a housing, not shown.

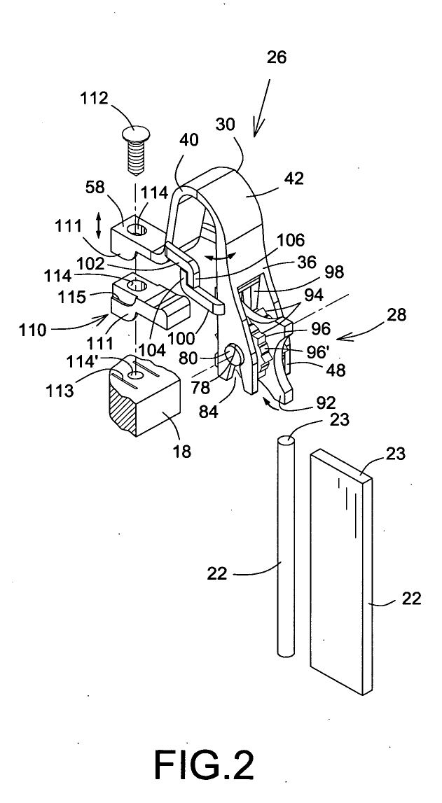

Referring now to FIGS. 1 and 2, the frame 16 includes a number of pre-shaped male dies (punches) 22. The frame 18 includes a corresponding number of pre-shaped female body openings 24, which are complementary to the male dies 22. The dies 22 and the openings 24 are pre-shaped according to a required template design and the pre-cutting patterns on the sheets 14. More specifically, the dies 22 and the aperture 24 are complementary to, i.e. aligned with, the cut-outs 12 defining the waste pieces 12 in the sheet 14 for tearing, punching, or otherwise removing the cut-outs 12, as waste pieces 12, when the dies 22 are extended towards frame 18 and through apertures 24. While rectangular or square shaped sheets 14 of material are illustrated throughout, it is to be understood that any type of sheet 14 shape may be used without deviating from the scope of the present invention. Moreover, the number of body apertures 24 and dies 22 may vary and depend on the design requirements of the finished template for the sheet 14 with the waste pieces 12 removed.

Reference is now made to FIGS. 1 through 6. The stripping device of the present invention is shown generally as 26 and is connected to the frame 18 in proximity to an aperture 24, typically with at least one stripping device 26 for each aperture 24. The stripping device 26 includes a stripping cogwheel, shown generally as 28, a supporting finger 34 connected on a respective connecting end 58 thereof to the frame 18 proximal the body aperture 24, and a connecting portion 30 connecting at least one, and preferably first and second, cogwheel arms 36, on which the cogwheel 28 is rotatably mounted, to the supporting finger 34. The connecting portion 32 is resilient and arcuate, i.e. curved, with the supporting finger 34 located extending from a first connecting side 40 thereof and the arms 36 and cogwheel 28 located extending from a second connecting side 42 thereof, generally opposite the first connecting side 40 of the connecting portion 30. More specifically, the connecting portion forms a concave curve or arc extending between the first and second connecting sides 40, 42 and the arms 36 and supporting finger 34. The cogwheel 28 on the arms 36 is disposed towards, and preferably at least partially in, the body opening 24 for intersecting and subsequent sliding contact with both the waste piece 12 and a portion of the die 22, for example the first die end 23, on a portion of the cogwheel 28 to strip the waste piece 12 away from the aperture 24 as the die 22 is passed through the aperture 24 in first direction shown by arrow D1. Further, the supporting finger 34, arms 36, and connecting portion 30 are preferably configured, for example sized and shaped, such that the cogwheel 28 extends at least partially beyond the connecting end 58 and at least partially into the body aperture 24.

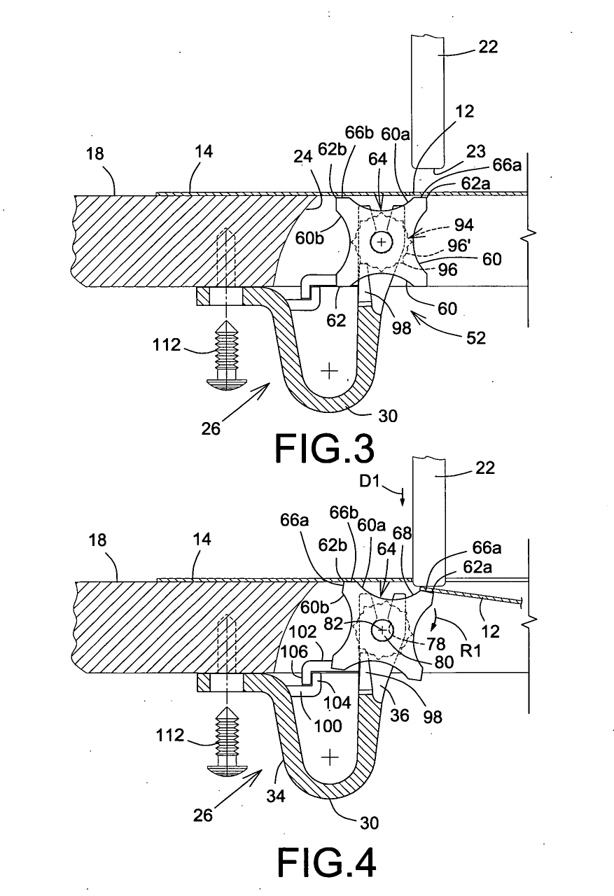

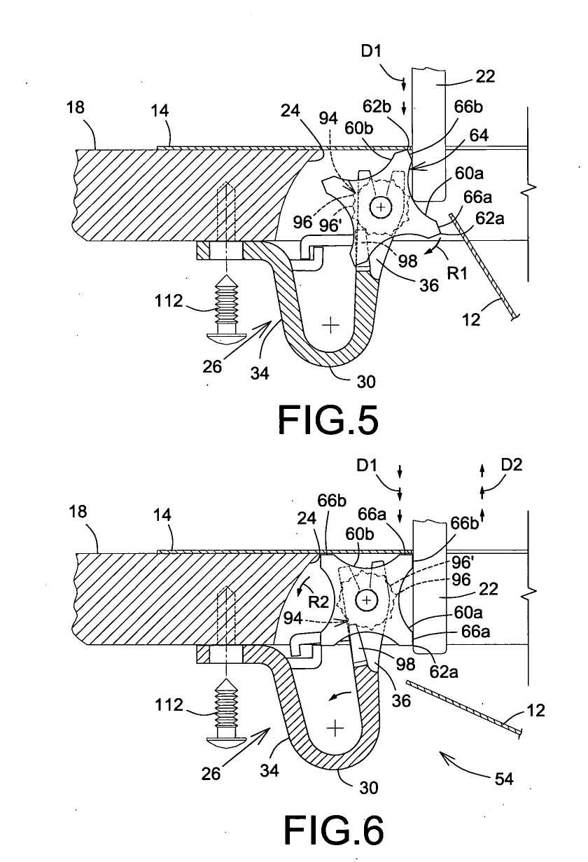

Referring now to FIGS. 2 through 6, the cogwheel 28 is described in greater detail. The cogwheel 28 is rotatably mounted on at least one, and preferably both, arms 36 on an axle 80 defining a rotational axis 82 for the cogwheel 28, the axle 80 extending therethrough and being mounted in axle mounting apertures 78 situated in the extending ends 48. The cogwheel 28 has at least three (3), and preferably four (4), adjoined peripheral faces 60, preferably of identical dimension and shape, which form the shape of the cogwheel 28. Thus, for the embodiment shown, the cogwheel 28 is preferably square in shape. The faces 60 are connected to one another at corresponding edges 62 which form corners between adjacent faces, for example 60a 60b. More specifically, each face 60 has respective longitudinally opposed first and second corresponding edges, for example 62a, 62b for face 60a with a first, leading, edge 62a being alignable proximal to and in partially overlapping register with the die 22, for a first configuration shown generally as 52 in FIG. 3 of the device, for intersecting the die 22 extending in direction D1 and subsequent sliding contact of the die 22 with at least a portion of the face 60. The sliding contact, as explained below, by the die 22 with the waste piece 12 and the face 60 causes the cogwheel to rotate in first rotational direction, shown by arrow R1, as the device 26 is moved, as shown in FIGS. 4 and 5, into a second configuration shown generally as 54 in FIG. 6. The second edge 62b of the face 60 is situated distal the die 22 when the first edge 62a of face 60 is aligned proximal the die 22 and in register therewith.

Each face 60 preferably has a recess, shown generally as 64, situated between the first and second edges 62 and which extends inwardly relative the respective first and second edges 62 of the face 60, and therefore towards the axis 82. More specifically, the recess 64 is preferably arcuate, i.e. curved, and thus curves concavely inwardly relative the edges 62 towards the axis 82. Each recess 64 is preferably spaced apart from the first and second edges 62, preferably equidistant thereto, first and second edges 62. More specifically, each face 60 preferably has a respective first planar flat portion 66a, extending from the first edge 62 thereof to the recess 64, the respective first flat portion 66a being alignable proximal and in at least partially overlapping register with the die 22, for the first configuration 52, for initial contact with the die 22. The die 22 then moves in sliding contact with the first planar flat portion 64 and waste piece 12 into the concave curvature of the recess 64, which facilitates rotation of the cogwheel 22 in rotational direction R1 during stripping of the waste piece 12. Optionally, each face 60 may also have a respective second flat planar portion 66b, generally planarly aligned with the first flat portion 66a extending from the recess 64 to the second edge 62b.

Referring now to FIGS. 2, 3, 4 and 5, the connecting portion 30, and optionally arms 36 and supporting finger 34, is resilient and made of a resilient material, such as hardened steel or resilient plastic. For example, for the embodiment shown, the connecting portion 30 is a folded over, and thus curved, single piece of hardened steel. In the first, default configuration 52, in which the die 22 is separated from the cogwheel 28 and one of the faces, say face 60a, faces towards the die 22 and the waste piece 12 and sheet 14, the inherent resilience of the connecting portion 30, as well as of the arms 36 and finger 34 when also resilient, biases the cogwheel 28 away from the supporting finger 34 such that the cogwheel 26 is aligned with the die in overlapping register therewith, and specifically with the first flat portion 66a or edge 62a of the face 60a. Thus, the connecting portion 30, and optionally arms 36 and finger 34, automatically aligns cogwheel 28, when the die 22 separated therefrom as in the first configuration 52, for contact, initially on the first edge 62a or flat portion 66a, with the waste piece 12 and the die 22 and subsequent rotation in rotational direction R1, by sliding of the die 22 along the flat portion 66a and then recess 64, with the waste piece 12 disposed therebetween, by extension of the die 22 in direction D1, shown in FIGS. 3 and 4. Thus, the waste piece 12 is deflected, and thereby stripped, by friction between the sheet 14, die 22, and face 60 away from the sheet 14 and through the aperture 24. It should be noted that the face 60 may become briefly separated from the die 22 and waste piece 12 during the rotation of the cogwheel 28 in rotational direction R1, notably as the cogwheel 28 rotates of flips between the flat portion 66a and the recess 64, which only facilitates stripping in that the waste piece 12 may then freely fall or be deflected away, as described above, from the sheet 14.

Reference is now made to FIGS. 3, 4, 5, and 6. As the die 22 continues to move in direction D1, sliding along recess 64 towards second edge 62b and second flat portion 66b, the die 22 pushes or biases the cogwheel 28 inwardly toward finger 34, especially as the die approaches the outward curving recess portion 68 of recess 64 leading up to the first flat portion 66a and edge 62a. Concurrently, the ongoing movement of die 22 in first direction D1 and sliding along face 60a continues to rotate the cogwheel 28 in rotational direction R1 moving the second edge 62b and flat portion 66b of face 60a towards the die 22 and a next adjacent face 60b of the cogwheel 28 towards a position facing the aperture 24 until the device is in second configuration 54. In the second configuration 54, the face 60a extends substantially alongside the die 22 in an orientation generally parallel the first direction D1 and in at least partial side contact with the die 22, and preferably with both first and second edges 62a, 62b and flat portions 66a, 66b in side contact with the die 22, which inwardly biases the cogwheel 28 towards the finger 34. The next adjacent face 60b, for the second configuration 54, is positioned facing the aperture 24, preferably perpendicular the die 22. Thus, in the second, compressed, configuration 54, the next adjacent face 60b is thus oriented for subsequent sliding of the die 22 therealong, once the die 22 is removed from side contact with the face 60a, for example when the die 22 is retracted in opposing second direction D2, which causes the cogwheel 28 to be biased resiliently away from the finger 34, thus placing the adjacent face 60b in overlapping register with die 22 and returning the device 26 to the first configuration 52 for punching and stripping of the waste piece 12 from a new sheet 14. Thus, the device moves, automatically and conveniently, from first configuration 52 to second configuration 54, and back to first configuration, with the cogwheel 28 rotated in the first rotational direction R1 to position the next adjacent face 60 for subsequent stripping of the next waste piece 12 as the die 22 is inserted and removed through the aperture 24 to remove the waste piece 12 from the sheet 14. This continuous and automatic realignment of the device 26 for subsequent stripping allows for increased speed of processing with the press 10. Further, deflection of the waste piece 12 reduces risks of paper jams.

To ensure that the cogwheel 28, and more specifically the next adjacent face 60 is properly aligned with the die 22 when the die 22 is removed from contact therewith during return of the device 26 from the second configuration 54 to the first configuration 52, the device 26 may optionally have a ratchet arrangement, shown generally as 90, connected to the cogwheel 28, which impedes rotation of the cogwheel 28 in a second rotation direction R2 generally opposed to the first rotation direction R1. The ratcheting arrangement 90 generally includes at least one ratchet wheel 94, well known in the art, having ratchet teeth 96, 96′ disposed circumferentially therearound and at least one ratchet finger 98 for each ratchet wheel 94. Ratchet teeth 96′, positioned alternately with teeth 96, are typically flattened and are generally used to prevent small rotational wobbling of cogwheel 28 relative to arms 36 and ratchet fingers 98, when stopped thereby. For example, and as shown in FIG. 2, the ratchet arrangement 90, may have first and second ratchet wheels 94, connected to the cogwheel 28 in alignment with a wheel side 92 of the cogwheel 28 and mounted on the axle 80 therewith, and first and second ratchet fingers 98. The first and second ratchet fingers 98 are configured, for example positioned and aligned connected to and extending form the arms 36, for contact with the ratchet wheel 94, notably the teeth 96 thereof, whenever the cogwheel 98 is rotated. The ratchet fingers 98 and teeth 96 are further configured, as is typical of most ratcheting arrangements known in the art, such that a portion of the ratchet finger 98 will be abuttingly immobilized against one of the teeth 96 or become abuttingly immobilized therein when the ratchet wheel 94 and thereby the cogwheel 28 is rotated in direction R2. Thus, the teeth 96 abuttingly stop rotation of the cogwheel 28 in rotational direction R2, essentially limiting rotation of the cogwheel 28 to first rotational direction R1. Advantageously, impeding of the rotation of the cogwheel 28 in rotational direction R2 also reduces the risk that the waste piece 12 will be pulled in that direction R2, thus reducing the risk of the waste piece 12 jamming in the aperture 24 or another part of the press 10.

To ensure that the resilient action of the connecting portion 30, and arms 36 and finger 34 when resilient, do not result in the cogwheel 28 being biased too far away from the finger 34, upon release from the second configuration 54, at least one arm 36 has a respective arm hooking member 100 connected thereto and extending towards the said supporting finger 34. For each arm hooking member 100, there is a respective finger hooking member 102 extending from the supporting finger 34 towards the arm 36. Each arm hooking member 100 has an arm member flange 104 extending therefrom towards the finger hooking member 102 and each finger hooking member 102 has a respective finger member flange 106 extending therefrom towards the arm hooking member 100. The hooking members 100, 102 and flanges 104, 106, forming a device retaining member against opening of the device 26 in preventing the arms 36 from moving away from the finger 34 beyond the first configuration 52, are configured, for example sized, shaped, or positioned, such that the arm member flange 104 is configured slidably movable, i.e. in sliding contact with the finger hooking member 102 between the finger member flange 106 and the supporting finger 34, with the arm member flange 104 abuttingly hooking against the finger member flange 106 when the device 26 is in the first configuration 52, which stops further movement of the cogwheel 28 away from the supporting finger 34. The hooking members 100, 102 and flanges 104, 106 thereby prevent resilient biasing of the cogwheel 28 beyond said first configuration 52 when the die 22 is removed from side contact with the cogwheel 28. As shown, there are preferably first and second arm hooking members 100 with respective arm member flanges 104, finger hooking members 102, and finger member flanges 106 therefor.

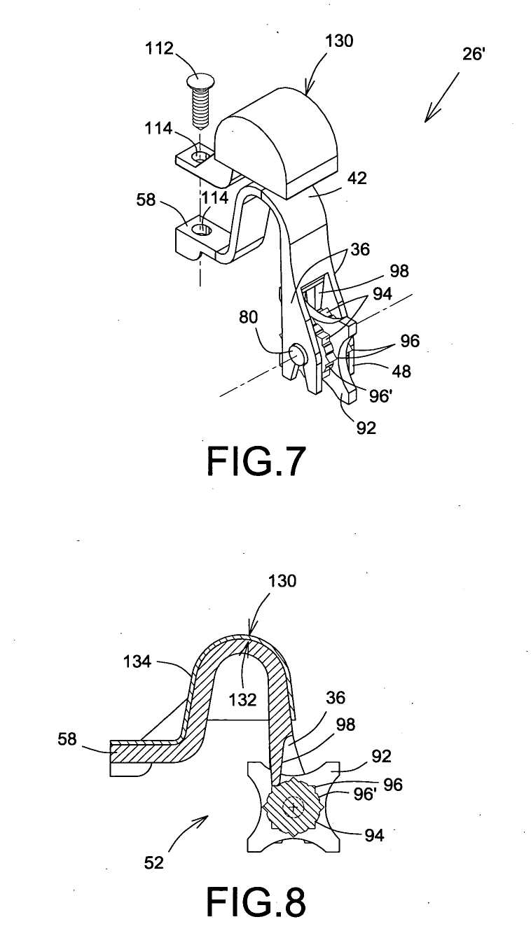

Alternatively, and as shown in FIGS. 7 and 8, an alternative embodiment of the device 26′ may have a cap, shown generally as 130, forming a device retaining member and which covers both sides 40, 42 of the connecting portion 30, and optionally over a portion of the arms 36 and support finger 34. The cap 130 is sized and shaped such that the connecting portion 30, the support finger 34, and arms 36 abut with inner cap walls 132 of the cap 130 when the device is in the first configuration 52, with the cogwheel 28 being rotated and biased inwardly as previously described when the device 26 is moved into the second configuration 54. Thus, as with members 100, 102, which may be omitted when the cap 130 is deployed, the cap 130 abuttingly stops the arm 36 from biasing outwardly relative the support finger 34 beyond the first configuration 52. The cap 130 is typically connected to the connecting end 38 using bolt or screw 112 which connects a connecting member 134 of the cap 130 configured for extending along and over the support finger 34 to the connecting end 38.

The extending ends 48 may, optionally, have tapered slots 84 which flare outwardly from the mounting apertures 78 and through which the axle 80 may be inserted and then snappably placed or inserted into the mounting apertures 78. Thus, the cogwheel 28 and axle 80 may be easily and removably mounted.

As shown in FIG. 2, an optional spacer 110 may be included with device and which may be connected between the connecting end 58 and the frame 18 with screw or bolt 112 inserted through screw apertures 114 and securely engaged in a corresponding screw hole 114′ of the frame 18. The spacer 110 spaces the connecting end 58 further away from the frame 18, and thus may be deployed to space the cogwheel 28 further away, or less further into, the aperture 24 than would be the case if the connecting end 58 alone was connected to frame 18 with screw 112.

Connecting end 58, as well as spacer 110, typically includes at least one, preferably two, rotational locking and positioning guides 111 adapted to engage corresponding guide slot holes 113 of the frame 18 adjacent screw hole 114′. When spacer 110 is used, the latter typically includes guide recesses 115 to guidingly receive the positioning guides 111 of the connecting end 58 therein. The positioning guides 111 with corresponding slot holes 113 prevent any possible rotation of the device 26 about the screw axis that would move the cogwheel 28 away from the corresponding die 22, and therefore prevent proper operation of the device 26.

While specific embodiments of the stripping device have been described, those skilled in the art will recognize many alterations that could be made within the spirit of the invention, which is defined solely according to the following claims.

I claim:

1. A stripping device for stripping a waste piece from a sheet of material by a die of a press when the press is extended in a first direction through an aperture of a frame of the press with which the waste piece is aligned, a first die end of the die tearing the waste piece from the sheet as the die extends through the sheet in the first direction the device comprising:
a resilient connecting portion having generally opposite first and second connecting sides;
a supporting finger extending from the first connecting side and having a connecting end connectable to the frame; and
a cogwheel rotatably mounted on an extending end of at least one arm extending from the second connecting side and including at least three adjoined peripheral faces connected to one another at corresponding edges, said cogwheel being aligned, in a first configuration for said device, with one face of said peripheral faces facing the waste piece and the die and being in register with the die and for rotating of the cogwheel by sliding of the die along a portion of said one face with the waste piece disposed therebetween as the die is extended in the first direction, thereby deflecting the waste piece away from the sheet and through the aperture, and biasing the cogwheel inwardly towards said supporting finger until said one face, in a second configuration for said device, extends substantially alongside the die in an orientation generally parallel to the first direction and in at least partial side contact therewith and a next adjacent face of said peripheral faces is positioned for subsequent sliding of the die therealong with said cogwheel being resiliently biased away from the supporting finger when said die is removed from side contact therewith, said device being returned thereby to said first configuration.

2. The stripping device of claim 1, wherein said at least three adjoined peripheral faces comprises four adjoined peripheral faces.

3. The stripping device of claim 1, wherein said peripheral faces are of identical shape and dimension.

4. The stripping device of claim 1, wherein for each said face, said corresponding edges comprise longitudinally opposed first and second edges, said respective first edge being alignable, for said first configuration, proximal to and in register with the die and with the second edge distal the die for enabling contact of the die with the first edge when moved in the first direction.

5. The stripping device of claim 1, wherein each peripheral face comprises a respective recess which extends inwardly relative said edges.

6. The stripping device of claim 5, wherein and each said respective recess is spaced apart from said respective first edge.

7. The stripping device of claim 5, wherein said respective recess is also spaced apart from said second edge.

8. The stripping device of claim 6, wherein said respective recess is equidistant said respective first and second edges.

9. The stripping device of claim 5, wherein said respective recess is curved concavely inwardly relative said respective first and second edges.

10. The stripping device of claim 5, wherein the cogwheel is configured for initial contact of the die proximal said respective first edge of said one face when the die is moved in the first direction and for subsequent sliding of the die along a recess portion, proximal said first edge, of said respective recess, said cogwheel being rotated and biased towards said supporting finger as the die slides along said respective recess.

11. The stripping device of claim 5, wherein each face has a respective first flat portion, said respective first flat portion extending from said first edge to said recess, said respective first flat portion being alignable in register with said die for said first configuration for initial contact with the die when said die is moved in the first direction to cause said cogwheel to rotate towards said second configuration.

12. The stripping device of claim 11, further comprising, for each face a respective second flat portion extending between said recess and said respective second edge.

13. The stripping device of claim 5, wherein, in said second configuration, said first and second edges of said one face abut against the die.

14. The stripping device of claim 1, wherein said at least one arm is a first arm and a second arm and said cogwheel is rotatably mounted between arms on an axle extending therebetween, said axle defining a rotational axis for around which said cogwheel rotates.

15. The stripping device of claim 14, wherein extension of said die in the first direction causes said cogwheel to rotate in a first rotational direction about said rotational axis, said device further comprising a ratchet arrangement connected to said cogwheel disposed between said arms, said ratchet arrangement impeding rotation of said cogwheel in a second rotational direction opposite said first rotational direction.

16. The stripping device of claim 15, wherein said ratchet arrangement comprises at least one toothed ratchet wheel connected to the cogwheel and mounted therewith upon the axle and, for said ratchet wheel, a respective ratchet finger extending from one of said arms and aligned for contact with teeth of said ratchet wheel when said cogwheel and said ratchet wheel, are rotated, said teeth being configured for abuttingly stopping rotation of said ratchet wheel, and thereby said cogwheel, in said second rotational direction.

17. The stripping device of claim 1, wherein said connecting portion is curved and forms a concave arc extending between said first and said second connecting sides and said at least one arm and said supporting finger.

18. The stripping device of claim 1, wherein said at least one arm is also resilient, said arm being biased towards said supporting finger as said device moves from said first configuration to said second configuration and away from said supporting finger as said device moves form said second configuration to said first configuration.

19. The stripping device of claim 1, wherein said arm and said supporting finger are sized and shaped such that said cogwheel extends at least partially into said aperture.

20. The stripping device of claim 1, further comprising, for each said arm, a respective arm hooking member connected thereto and extending towards said supporting finger and a respective finger hooking member extending from said supporting finger towards said arm, said respective arm hooking member having a respective arm member flange extending therefrom towards said respective finger hooking member, said respective finger hooking member having a finger member flange extending therefrom towards said arm hooking member, said respective arm member flange being slidably movable along said respective finger hooking member between said finger member flange and said support finger and abutting said respective finger member flange when said device is in said first configuration, thereby preventing resilient biasing of said cogwheel beyond said first configuration.

21. The stripping device of claim 1, further comprising a spacer connectable to said connecting end and the frame, with said spacer being disposed therebetween, for spacing said cogwheel away from said aperture.

22. The stripping device of claim 1, wherein said connecting end includes at least one rotational locking and positioning guide extending therefrom for engaging a corresponding slot hole on the frame.

23. The stripping device of Claim 1, further comprising a cap connected to the connecting end and covering the connecting portion and partially covering said arm and said supporting finger, said cap being configured for abutment of the finger and arm with an interior wall thereof when said device is in said first configuration, thereby preventing said arm from being biased outwardly away from said finger beyond said first configuration.
